(19) United States
(12) Patent Application Publication
(10) Pub. No.: US 2007/0144152 A1
(43) Pub. Date: Jun. 28, 2007

(54) Procedure and control unit to operate an integrated SCR/DPF system

(75) Inventor: Hartmut Lueders, Oberstenfeld (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/641,486

(22) Filed: Dec. 18, 2006

(30) Foreign Application Priority Data
Dec. 23, 2005 (DE) 10 2005 061 873.1

(51) Int. Cl. B01D 53/34; F01N 3/00; B01D 50/00; B32B 27/02; F23J 11/00

(52) U.S. Cl. 60/286; 422/168; 60/297; 60/295

(57) ABSTRACT

A procedure is introduced to operate a particle filter, which is disposed in the exhaust gas stream of an internal combustion engine and which collects particles from the exhaust gas and possesses the capability for selective catalytic reduction of nitrogen oxides, whereby the selective catalytic reduction is set off by the supply of a reducing agent. The procedure characterizes itself in such a manner, that the supply of the reducing agent is temporarily decreased during a thermal regeneration of the particle filter. Moreover a control unit is introduced, which controls the operation of the procedure.

The invention concerns a procedure and a control unit according to the preambles of the independent claims.

Such a procedure and such a control unit are each respectively known from the German patent DE 103 23 607 A1. This text shows in FIG. 2 an integrated SCR/DPF-System (SCR=selective catalytic reduction, DPF=diesel particle filter) consisting of a particle filter, which is equipped with catalytic centers, which possess a capability for the selective catalytic reaction.

A particle filter has a structure with a multiplicity of canals, which alternately are so closed that the particle laden exhaust gas has to stream through porous walls of the honeycomb body. In so doing, the particles are deposited in the pores. Depending upon the porosity of the ceramic honeycomb body, the degree of effectiveness of the filter fluctuates between 70 and 90%. In order to avoid an inadmissibly high exhaust gas back pressure due to particle residues, the particle filter must be regenerated.

An SCR-catalytic converter facilitates a selective catalytic reduction of nitrogen oxides to molecular nitrogen, whereby ammonia serves as the reducing agent, which in a known manner can be derived from a urea-water-solution in a hydrolysis catalytic converter connected upstream from the SCR-catalytic converter. The conversion of the urea-water-solution can also take place at the SCR-catalytic converter, so that a separate hydrolysis catalytic converter must not necessarily be present.

The “selective catalytic reaction” is described in connection with the construction of a SCR-catalytic converter in D. Schoeppe et al., “A closed-loop controlled exhaust gas aftertreatment system to meet future emission limits for diesel motors”, progress reports, VDI, file 12, number 267, volume 1 (1996), 17^{th} international Viennese motor symposium, pages 332-353. The SCR-catalytic converter converts a reducing agent into ammonia (NH₃), with which the nitrogen oxides are selectively and catalytically converted to nitrogen and water.

In the integrated SCR/DPF-system known from the German patent DE 103 23 607 the structure of the particle filter contains SCR-active catalytic centers. In order to guarantee the desired particle reduction in an enduring and reliable manner, the soot collected in the particle filter should be removed from time to time. This occurs as a rule by means of a combustion of the sooty particles at an elevated particle filter temperature, which is also called thermal regeneration. In a vehicle with a diesel motor and a particle filter, such a thermal regeneration is typically set off after driving several hundred kilometers by an elevation of the exhaust gas temperature. The exhaust gas temperature can, for example, thereby be set off by selective degradations of the efficiency of the engine's combustion.

During such regenerations of an integrated SCR/DPF-system, offensive odors occur.

With regard to this background information, the task of the invention is the description of a procedure and of a control unit of the kind mentioned at the beginning of the application, which allows a regeneration of an integrated SCR/DPF-system without the occurrence of offensive odors.

This task is solved with a procedure and a control unit of the kind mentioned at the beginning of the application in each case by means of the distinguishing characteristics of the accompanying independent claim. It was recognized during an analysis of the odor problem that the offensive odors were set off by a release of ammonia, which occurred during an increase in the system temperature. By way of the decrease in the supply of the reducing agent before the thermal regeneration, consumed ammonia is no longer or to a decreased extent replaced at the SCR active catalytic substances. During a thermal regeneration of the particle filter, only a small amount or no ammonia is then released.

It is thus preferred that the supply of the reducing agent is reduced already before the thermal regeneration. In so doing, stored ammonia is consumed at the catalytic centers by means of the continuing SCR-reaction, before it can come to a desorption of ammonia, which is thermally contingent.

It is also preferred that a stored mass of ammonia in the particle filter is reduced from an initial value of the mass to a second value of the mass, before the particle filter reaches a temperature at which the stored up soot combusts. The second value of the mass corresponds thereby preferably to a lower ammonia level standard, at which no significant amounts of ammonia can be desorbed even at an elevated temperature. Thus, a released amount of ammonia is then no longer significant, if its odor under normal conditions cannot be noticed.

It is additionally preferable in order to avoid offensive smells that the supply of the reducing agent also remains reduced during the thermal regeneration.

Provision is made in an additional preferred embodiment for the supply of the reducing agent to be again elevated after a thermal regeneration. The nitrogen oxide conversion capability is interfered with by the reduced supply of the reducing agent. The elevation of the supply of the reducing agent again removes the interference. The nitrogen oxide emissions are thereby only temporarily interfered with during the relatively seldom occurring thermal regeneration. The duration of the interference can thereby be shortened, in that the elevation of the supply of the reducing agent occurs in such a way at the beginning, that an ammonia storage area of the integrated SCR/DPF-system is filled again quickly. This can occur by means of a short term excessive supply of the reducing agent.

In order to further reduce the interference of a nitrogen oxide conversion and in order to minimize the increased fuel consumption, which is connected with a thermal regeneration of the integrated SCR/DPF-system, the beginning of a regeneration is preferably controlled as a function of a measurement for a flow resistance of the particle filter. If the measurement for the flow resistance exceeds a threshold value, a thermal regeneration is set off or the triggering is prepared. Such a demand justified triggering results preferably due to the fact, that the measurement is ascertained from the signal of a pressure differential sensor, which ascertains a difference in pressures in front of and behind the particle filter. Alternatively or additionally the measurement for the flow resistance can, however, also be formed as a function of the operating parameters of the particle filter by means of a computer model.

Additional advantages result from the description and the figures provided.

It is understood, that the previously stated characteristics and the subsequent characteristics yet to be explained are not only applicable in the combination given in each case, but also in other combinations individually without departing from the scope of the invention at hand.

Examples of embodiment of the invention are depicted in the drawings and are explained in detail in the following description. The following are shown respectively schematically:

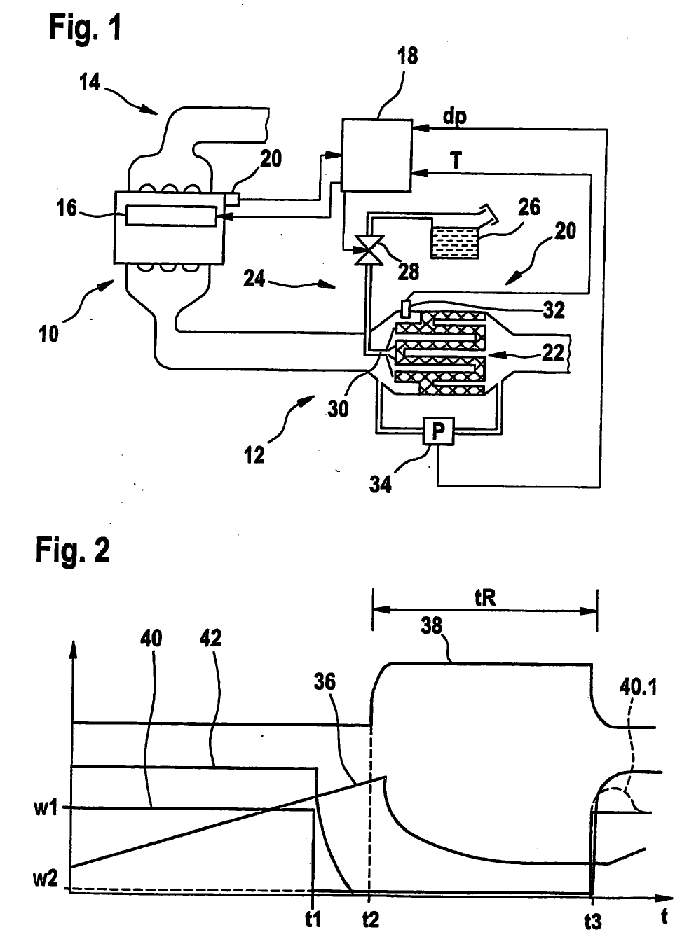

FIG. 1 an internal combustion engine with an integrated SCR/DPF-module; and

FIG. 2 chronological progressions of different operating parameters of the integrated SCR/DPF-module.

FIG. 1 shows an internal combustion engine 10 together with an emission control system 12. Air is delivered to the internal combustion engine from an intake air manifold. By means of a fuel metering device 16, fuel is metered to the air being delivered and the mixture of fuel and air created from that is combusted in the combustion chambers of the internal combustion engine 10 after a compression (self) ignition or an ignition from an outside source. At the same time the internal combustion engine 10 and the fuel injection 16 is controlled by a control unit 18, which is supplied with signals of sensors 20 by way of operating parameters of the internal combustion engine 10 as well as if need be by way of a torque selection of the driver as a basis for the open-loop control of the internal combustion engine 10 and the fuel injection 16. It is understood, that the enumeration of the operating parameters at this point is not final and that modem internal combustion engines 10 have as a rule a multiplicity of additional sensors.

For the purpose of exhaust gas purification, the known emission control system 12 of FIG. 1 contains at least an integrated SCR/DPF-module 20, in which a particle filter and a SCR-catalytic converter are integrated into a structural unit, which can be separated without damaging the SCR-catalytic converter and/or the particle filter. The SCR/DPF_module 20 represents with them a particle filter 20, which is disposed in the exhaust gas stream of the internal combustion engine 10. The module collects particles from the exhaust gas and possesses a capability for selective catalytic reduction of nitrogen oxides, whereby the selective catalytic reduction is set off by an influx of a reducing agent.

The integrated SCR/DPF-module 20 has a structure 22, in which alternately closed canals are so designed, that the canals, which are open facing the entrance of the SCR/DPF module, and are closed facing the opposing exit and vice versa. The exhaust gas of the internal combustion engine 10 must, therefore, in the emission control system according to FIG. 1 diffuse through the porous walls of the structure. During the diffusion sooty particles are deposited in the porous walls of the structure 22.

The integrated SCR/DPF-module 20 is so constituted, that exhaust gas passing through it comes in contact with catalytic centers. In so doing, materials of the catalytic centers are so selected, that a SCR-capability results. This capability can, for example, be produced in such a manner, that the surface areas of the alternately closed canals of the structure 22 are covered with a gas permeable catalytic layer. The structure 22 serves in this case as a supporting structure for the SCR-active coating as well as a particle filter, in which the sooty particles are eliminated. Alternatively and/or additionally, the catalytic layer can also be located in the porous walls of the canals.

The catalytic coating of the canals and/or the pores of the structure 22 of the SCR/DPF-module 20 facilitates a selective catalytic reduction of nitrogen oxides to molecular nitrogen, whereby ammonia serves as the reducing agent. The reducing agent ammonia is derived in one embodiment by means of a hydrolytic reaction in the SCR/DPF module 20 from a urea-water-solution, which is metered from a reducing agent metering system 24 to the exhaust gas in front of the SCR/DPF-module 20 or the structure 22. The reducing agent metering system 24 has essentially a reducing agent tank 26, a metering valve 28 and a jet 30. The metering valve 28 is controlled as a function of operating parameters of the internal combustion engine 10 by the control unit 18. It is, however, understood, that the invention is not dependent upon a specific kind of production of the reducing agent.

In this context especially the temperature T of the emission control system 12 or one of its components belongs to the operating parameters of the internal combustion engine 10. For the acquisition of the temperature T, provision is made in FIG. 1 for a temperature sensor 32, which acquires the temperature of the SCR/DPF-module 20. Provision can be made, however, for such a temperature sensor 32 at another point in the emission control system 12. As additional alternatives, the temperature T used for the control of the internal combustion engine 10 and the metering valve 28 can be formed as a model from additional operating parameters of the internal combustion engine like the amount of air to fill the combustion chambers, the amount of metered fuel, et cetera.

With an increasing mass of deposited sooty particles, the flow resistance of the SCR/DPF-module increases and with that the exhaust gas back pressure. In order to avoid an inadmissibly high exhaust gas back pressure due to particle residue, the SCR/DPF-module must be regenerated.

In the embodiment of FIG. 1 a pressure differential sensor 34 acquires a difference dp of the pressures in front of and behind the SCR/DPF-module and transmits the acquired dp-value to the control unit 18. The control unit 18 compares the pressure differential dp or a value derived from the pressure differential dp for the exhaust gas resistance of the SCR/DPF-module 20 with a threshold value and sets off a thermal regeneration of the SCR/DPF-module 20 when the threshold value has been exceeded. Alternatively or additionally the regeneration can also be set off as a function of the driving distance covered or as a function of a loading of the SCR/DPF-module with soot, which has been modeled from operating parameters of the internal combustion engine 10 over respectively many operating phases.

FIG. 2 shows chronological progressions of different operating parameters of the integrated SCR/DPF-module 20 during and after a thermal regeneration when implementing one of the examples of embodiment of a procedure according to the invention.

The curve 36 shows the progression of the pressure differential values dp at a certain value of the exhaust gas mass stream, while the curve 38 shows the progression of a temperature of the SCR/DPF-module. In this context it must be expressly pointed out, that the depiction of FIG. 2 is purely qualitative. Typical regeneration durations lie in the range of several minutes. The regeneration duration distinguishes itself in the curve 38 in the width of the plateau with an elevated temperature.

The loading of the SCRIDPF-module 20 with soot on the other hand increases possibly over a distance of several hundred kilometers and at the same time over several hours of operation before a thermal regeneration is set off. The increase in the pressure differential (dp) (curve 36), in which an increased loading of the SCR/DPF-module with soot is displayed, is for reasons of clarity is more steeply depicted than is to be expected in actual systems.

The SCR/DPF-module 20 first filters sooty particles out of the exhaust gas of the internal combustion engine 10. Chronologically parallel to that, nitrogen oxides in the exhaust gas of the internal combustion engine 10 are reduced in the SCR/DPF-module 20 to molecular nitrogen. In order to maintain the selective catalytic reaction, a reducing agent is at first continually added to the exhaust gas. The metering of the reducing agent occurs by way of the valve 28 and the jet 30 in FIG. 1. The curve 40 in FIG. 2 depicts a mass flow of the reducing agent to the exhaust gas of the internal combustion engine 10. The reducing agent releases ammonia in the exhaust gas and/or in the SCR/DPF-module. With the continual release of ammonia and the consumption of ammonia occurring chronologically parallel to it by means of the selective catalytic reduction of the nitrogen oxides, a certain mass of ammonia is stored in the SCR/DPF-module. The stored mass of ammonia is represented in FIG. 2 by the curve 42.

At the point in time 11 a measurement for a flow resistance of the SCR_DPF-module 20 reaches a threshold value. The measurement can be formed from the signal dp of the pressure differential sensor 34 and/or as a function of the operating parameters of the SCR/DPF-module 20 and/or of the internal combustion engine 10 using a computer model. The control unit 18 registers the fact that the threshold value has been exceeded and sets off a thermal regeneration of the SCR/DPF-module 20 by way of an elevation of the exhaust gas temperature T at the entrance of the SCR/DPF-module 20. The time duration of the increase in temperature determines the time duration tR of the regeneration. Furthermore, the control unit 18 reduces the supply of the reducing agent during the thermal regeneration. Ammonia stored in the SCR/DPF-module 20 and consumed during the selective catalytic reduction is for this reason temporarily no longer replaced by an additional delivery of the reducing agent. The amount of released ammonia is thereby reduced, which is not consumed during the nitrogen oxide reduction and that can escape behind the SCR/DPF-module 20 and cause offensive odors.

In a preferred embodiment the supply of the reducing agent is already reduced before the thermal regeneration. When the threshold value is exceeded by the measurement for the flow resistance, a preparation of the thermal regeneration initially is set off. The actual thermal regeneration is then delayed in being set off.

Thus the ammonia stored in the SCR-DPF-module is consumed for the reduction of the nitrogen oxides, before the increase in temperature is set off. In the depiction of FIG. 2, a decrease in the supply of the reducing agent (curve 40) occurs initially at the point in time t1, at which the pressure differential reaches the threshold value. The threshold value is thereby so predetermined, that the SCR/DPF-module 20 can still continue to collect sooty particles, but should be regenerated soon thereafter. The internal combustion engine 10 is initially operated beyond the point in time t1 with a low exhaust gas temperature T. The loading of the SCR/DPF module 20 with sooty particles initially increases, when stored ammonia in the SCR/DPF-module 20 is consumed by the selective catalytic nitrogen oxide reduction. Not until a mass of ammonia stored in the SCR/DPF-module has decreased at a later point in time t2 from a first value w1 of the mass to a second value w2 of the mass is the temperature of the SCR/DPF-module raised beyond an ignition temperature of the soot collected in the module.

Subsequently the supply of the reducing agent also remains decreased during the thermal regeneration. In so doing, the decrease can go as far as a complete interruption of the supply of the reducing agent. It is, however, preferable, that a marginal reducing agent flow be maintained. In the process the nitrate monoxide resulting from the conversion of the precipitated carbon during the thermal regeneration can be converted to molecular nitrogen and water. Beside the nitrate monoxide resulting from the conversion of the carbon, nitrogen oxide emitted from the internal combustion engine 10 is, of course, converted by means of the selective catalytic reaction in the porous catalytic structure 82.

After a thermal regeneration, which ends at the point in time t3, the supply of the reducing agent is again increased, in order to again increase the nitrogen oxide reduction. At the same time the supply of the regeneration agent can also be increased excessively for a short time above the required dosage for steady state conditions in order to rapidly fill the ammonia storage of the SCR/DPF-module. This is depicted in FIG. 2 by the dashed line 40.1.

1. A method of operating a particle filter, which is disposed in an exhaust gas stream of an internal combustion engine and which collects particles from the exhaust gas stream and possesses a capability for selective catalytic reduction of nitrogen oxides, whereby the selective catalytic reduction is set off by supplying of a reducing agent, the method comprising temporarily decreasing the supply of the reducing agent during a thermal regeneration of a particle filter.

2. A method according to claim 1, wherein decreasing includes decreasing the supply of the reducing agent before the thermal regeneration.

3. A method according to claim 2, further comprising reducing a mass stored in the particle filter from an initial value of the mass to a second value of the mass, before the particle filter reaches a temperature, at which collected soot combusts.

4. A method according to claim 3, wherein reducing includes the supply of the reducing agent remaining reduced during the thermal regeneration.

5. A method according to claim 1, further comprising increasing the supply of the reducing agent after a thermal regeneration.

6. A method according to claim 1, further comprising setting off a beginning of a regeneration as a function of a measurement for a flow resistance of the particle filter.

7. A method according to claim 6, wherein setting off includes ascertaining the measurement for the flow resistance from a signal of pressure differential sensor, which acquires a difference in pressures in front of and behind the particle filter.

8. A method according to claim 6, wherein setting off includes forming the measurement for the flow resistance as a function of operating parameters of the particle filter by means of a computer model.

9. A control unit, which controls a supply of a reducing agent to a particle filter, which is disposed in an exhaust gas stream of an internal combustion engine and collects particles from the exhaust gas stream and possesses a capability for selective catalytic reduction of nitrogen oxides, which are released by means of the supply of the reducing agent, wherein the control unit temporarily decreases the supply of the reducing agent during a thermal regeneration of the particle filter.

10. A control unit according to claim 9, wherein the control unit controls an operation of one of the procedures according to claim 1.
